(19) United States
(12) Patent Application Publication
(10) Pub. No.: US 2024/0248462 A1
(43) Pub. Date: Jul. 25, 2024

(54) Method for Producing Film from a Total Quantity of Raw Materials Using a Film Extrusion Machine, and Computer Program Product for Carrying Out the Method

(71) Applicant: Windmöller & Hölscher KG, Lengerich (DE)

(72) Inventors: Martin Backmann, Lengerich (DE); Markus Bussmann, Lengerich (DE); Wolfgang Hoffmann, Lengerich (DE); Melanie Schuh, Lengerich (DE); Torsten Schmitz, Lengerich (DE)

(21) Appl. No.: 18/560,551

(22) PCT Filed: May 4, 2022
(86) PCT No.: PCT/EP2022/062005

§ 371 Date: Nov. 13, 2023

(30) Foreign Application Priority Data
May 14, 2021 (DE) 10 2021 112 620.7

(51) Int. Cl. G05B 19/418; B29C 48/92

(52) U.S. Cl. CPC G05B 19/41865; B29C 48/92; B29C 2948/92295

(57) ABSTRACT

The invention relates to a method for producing a film from a total quantity of raw materials using an extrusion machine, comprising the following steps:
detecting machine parameters relating to properties and/or settings of at least one film extrusion machine,
detecting film parameters relating to desired properties of the film,
detecting raw material parameters relating to properties of the raw materials,
inputting the detected parameters in a film production model,
calculating a selection and/or an amount of raw materials from the total quantity of raw materials based on the detected parameters and the film production model,
outputting information relating to the selection and/or the amount of raw materials.

The invention relates to a method for producing film from a total quantity of raw materials using a film extrusion machine, and a corresponding computer program product.

It is known that for the production of film with desired properties, production parameters are set in film extrusion lines. In the process, a plurality of production parameters is to be considered. For example, temperatures, pressures or other physical variables that act directly on the raw materials, the intermediate products and/or the finished film have to be set at many points. This applies, in particular, to setting, i.e., open-loop and/or closed-loop controlling the film extrusion line.

The properties of the film produced can then be characterized, particularly in the laboratory, but also during production. In particular, the actual fulfillment of a function of the film, but also measurable film parameters such as tear resistance or stretchability of the film, are examined.

In regard to the open-loop and/or closed-loop control of the film extrusion line, known solutions are mainly based on the experience and the knowledge of the operating personnel.

The same applies to the raw materials. Again, the raw materials are selected based on experience, experiments and the manufacturers' specifications on the raw materials.

Overall, the production of a film with desired properties may require lengthy preparatory work, which can also be expensive.

It is the object of the present invention to at least partially eliminate the aforementioned disadvantages. It is, in particular, the object of the present invention to produce a film with the desired properties more cost-effective and in a simple manner.

The above object is accomplished by a method having the features of claim 1 and a computer program product having the features of claim 10. Further features and details of the invention derive from the dependent claims, the description and the figures. Features and details which are described in the context of the method according to the invention naturally also apply in the context of the computer program product according to the invention and vice versa, respectively, so that reference is or can always be made to the individual aspects of the invention reciprocally with respect to the disclosure.

The method according to the invention relates to the production of film from a total quantity of raw materials using a film extrusion machine. The method comprises the following steps:
detecting machine parameters relating to properties and/or
setting at least one film extrusion machine,
detecting film parameters relating to desired properties of the film,
detecting raw material parameters relating to properties of the raw materials,
inputting the detected parameters in a film production model,
calculating a selection and/or an amount of raw materials from the total quantity on raw materials based on the detected parameters and the film production model,
specifying the selection and/or the amount of raw materials.

The method according to the invention is thus used to specify what subset of raw materials and/or what mass of the raw materials is to be selected from the total quantity of raw materials. The method according to the invention specifies said selection and or the amount. Within the context of the invention “total quantity” means the different raw material types, whereas the term “mass” or “amount” reflects the volume and/or the weight of each selected raw material.

Film extrusion machines can mean all extrusion machines, but also downstream components with which the raw materials can be converted into a film, but also downstream machine components such as stretching devices, to winding devices in which the film is wound up for the first time for transportation. An extrusion machine can operate according to the principle of a blown film line or a cast film line.

“Detecting” refers to different types of detecting. For example, unchangeable parameters can be detected once in a database. This is, for example, the case with geometrical properties of the film extrusion machine. Other parameters may change at intervals, such as details of the raw material available. Yet other parameters, such as the desired properties of the film, can be detected on an order-related basis. Accordingly, the parameters can also be detected on the basis of different characteristics. For example, the parameters are made available via databases which are, for example, stored in the memory of the film extrusion machine or decentrally in Internet portals. In this case, detecting would be referred to as “reading out data”. Order-related parameters, for example, can be detected via input devices such as a keyboard.

In the context of the method according to the invention, it is necessary to detect machine parameters and/or setting relating to at least one film extrusion machine. Machine parameters can be detected, in particular, during commissioning, during which, for example, geometric data of the film extrusion machine are stored in a database. Said geometric data include, in particular, the maximum number of layers, the maximum number of individual raw materials that can be used for each individual layer, the design of extruder screws for melting-on the raw materials, the width or circumference of the die lip, the thickness of the die lip. This list is not exhaustive and therefore not limiting with respect to the invention.

Detecting the settings relates to machine components, which can be controlled with respect to geometric properties such as the position, or with respect to physical values such as a temperature, a volumetric flow rate or a speed. As these settings are variable and can also be adjusted during film production, detecting the settings can refer to a range of values and not just to a single setting value.

Detecting raw material parameters refers to the properties of raw materials such as material composition, and information about their production parameters, but also grain size of the granules of these raw materials. However, raw material parameters may also include economic data such as price or availability at a certain point in time.

According to the present invention, the entirety of the detected parameters is provided to a film production model in a subsequent step. One of the core ideas is that the film production model then selects a selection and/or an amount of raw material from the entirety of available raw materials. This means, that contrary to the prior art, it is no longer necessary to manually determine the raw materials that match the desired properties of the film and procure said raw materials in the required amount and to subsequently set the film extrusion machine so that the desired film is produced from the procured raw materials. Rather, the method according to the invention uses the detected parameters within the film production model relative to each other and determines the appropriate raw materials that result in the desired film. Additionally or alternatively, the required amount of the raw materials is also calculated. The latter is, in particular, the case when the selection or subset of raw materials, meaning their number, matches the total quantity of raw materials. Within the context of the invention, the term “total quantity” means the total number of different raw materials and not their physical parameters such as weight, volume or density.

As subsequent step of the method according to the invention, the information about the selection and/or about the amount of raw materials is then output. Said output can be displayed on a monitor, for example, so that an employee of a film manufacturer can process this information further. However, said information may also be output directly or indirectly to an interface so that further electronic processing is possible. For example, it is conceivable that the information is output to a digital order system for the raw materials so that the required raw materials for the film production are ordered particularly fast. However, the information may also be output to a previously specified film extrusion machine so that said film extrusion machine independently obtains the raw materials from raw material supply facilities, in particular, silos, for example, via an automated system. Outputting the information to a storage facility in which an employee then commissions the required raw materials in the required amounts is also conceivable.

Further advantages may result if a recommendation is made as to which film extrusion machine should be selected for producing the desired film, if several film extrusion machines, in particular, different film extrusion machines for producing the film are generally available. Often, several film extrusion lines are available at a manufacturing facility that are different from one another with regard to the geometric data but also with regard to their physical parameters. In such a situation, it is possible to select one of these lines based on the film production model. For example, with a desired film with a five-layer structure, it may advantageous if the product is produced on a film extrusion line for films with at most a seven-layer structure.

The method according to the invention may also comprise a step in which, based on the raw materials, a prediction for the maximum possible output of the film extrusion machine, in particular, the selected film extrusion machine, is made. The maximum possible output does not only depend on the machine parameters, but primarily on the raw materials used. Based on this information, even the actually used machine parameters can be adjusted. The advantage of this approach is that the machine time required to produce the film is reduced so that the proportion of the cost of the machine time in the end product is reduced.

Furthermore, it may be advantageous, if the method according to the invention comprises a step in which the expected properties of the film based on the film production model are calculated. It may be that the film does not have all the desired properties, but that there are minor deviations, for example, if a required raw material cannot be processed according to the specifications. However, the properties of the film can be adjusted in this case and the actual properties can then be communicated so that they can be taken into account during subsequent film processing. Moreover, the desired properties and the expected properties can be verified through subsequent tests. This allows for an adjustment of the film production model.

It may even be that the desired properties of the film cannot be achieved at all, but deviate with regard to individual properties. This may be the case if a raw material is required but is not available within the total quantity of raw materials. In this case, the film production model can suggest or select an alternative raw material. In another case, raw materials may be specified, of which one cannot be processed as required in the film extrusion machine. The deviation from the desired properties of the film to expected properties of the film can be evaluated in such as case and the film manufacturer can make a decision.

It may be helpful here, if in the method according to the invention a step is carried out in which the tolerance limits with regard to at least one property of the film are detected. This way several selections and/or amounts of raw materials may be output. It is advantageous here, if additionally a comparison is made between a property of the desired film and the same property of the expected film. The properties may be prioritized. For example, it may be possible that a specific, non-relevant property has a greater tolerance, but, on the other hand, the tolerance limits for a relevant property, such as the stretchability of the film, can be set more narrowly.

Further advantages become apparent if the following step is added to the method according to the invention: considering previous orders when calculating the selection and/or the amounts of raw materials. Considering previous orders can be used, for example, to modify ratios between parameters prior to calculating to achieve greater precision of the results of the calculation. Overall, this measure results in an improvement of the film production model. This may ultimately result in a film that matches the desired properties even better.

It is also advantageous if the following steps are added method according to the invention: detecting batch-specific properties of at least a part of the raw materials, and considering said batch-specific properties. As a rule, nominally identical raw materials differ in their properties if they are produced at different times and, in particular, are not produced continuously. The same raw material is often produced again under slightly different conditions. Such information regarding the production conditions of the respective batch can be detected as part of the method according to the invention. Considering said information and, thus the batch-specific properties, achieves the object of the present invention even better.

To improve the method according to the invention in an advantageous manner, the following steps may be added:
detecting at least one property of the film,
calculating the deviation of said property from the property of the expected property of the film,
inferring at least one property of a raw material.

The properties of the film can be determined inline or offline in a downstream examination by direct or indirect investigations. These can be carried out in the film extrusion machine abut also in machines that process the film. However, precise examinations, for example in a laboratory, are also conceivable. In particular, quantitative data is determined for these properties, which is then compared to data on the expected properties. At least one property of a raw material can be inferred from the calculation. Based on this inference, raw material parameters can be verified, for example. The verification of the raw material parameters can be used, for example, to determine an error and, for example, output an error message. An error can be caused, when an incorrect raw material for producing the film was provided.

Also the subject of the present invention is a computer program product comprising instructions which, when the program is executed on a computer, cause the computer to carry out the steps of a method according to the invention. Thus, a computer program product according to the invention has the same advantages as those explained in detail with reference to a method according to the invention.

FIG. 1 schematic illustration of a film extrusion machine,

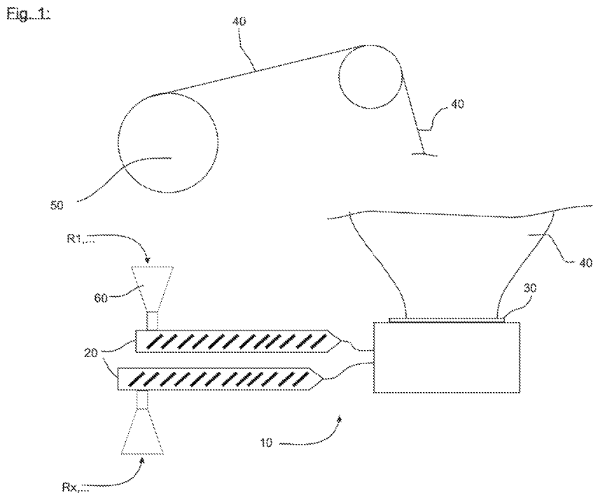

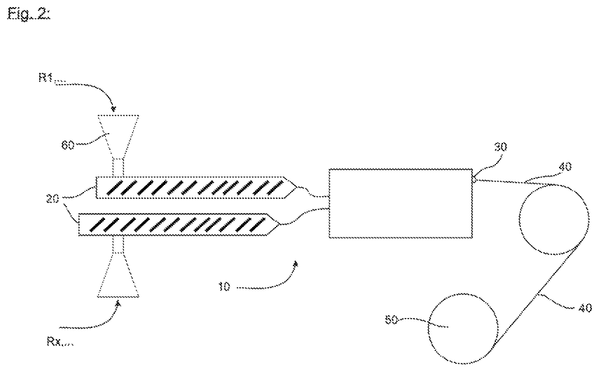

FIG. 2 schematic illustration of a different film extrusion machine,

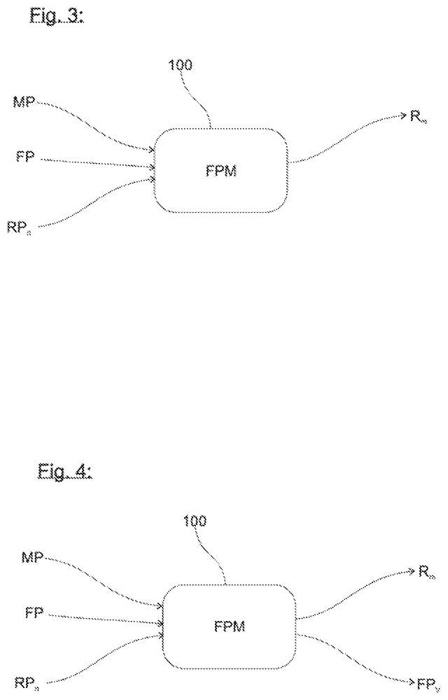

FIG. 3 schematic illustration of the sequence of a method according to the invention.

FIG. 4 schematic illustration of the sequence of a method according to the invention with an addition.

In FIGS. 1 and 2, film extrusion machines 10 are shown by way of example. The film extrusion machines have in common that they are equipped with extruders 20. Each individual extruder supplies the film extrusion machines with melted plastic material for a layer of the subsequent film. For this purpose, a first extruder is supplied with one or more raw materials R1, . . . via dosing devices 60, a second extruder is supplied with one or more raw materials Rx . . . in said manner. The raw materials are generally provided in the form of plastic granulate. The type and/or amount of the supplied raw materials are predetermined by the method according to the invention.

The method according to the invention can be carried out using a cast film or a blown film extrusion line according to FIG. 2. FIG. 1 shows a blown film line comprising the already described extruders 20. A film web or film 40 for short is discharged from the die 30, the die 30 being designed as an annular blow die. The film web is initially formed as bubble which is later laid flat. Said film, which then comprises two individual films placed one on top of the other, is wound counter-clockwise onto one winding roller 50 or, after cutting, onto two winding rollers.

The film extrusion machine in FIG. 2 is a cast film extrusion machine, which, as an example, is also equipped with two extruders 20 for different compositions. A film web 40 is discharged from the die 30, which film web cools down on a cooling roller and is subsequently wound onto a winding roller 50.

FIG. 3 schematically shows the process of the method according to the invention. A memory and computing unit 100 is provided with machine parameters MP relating to properties and/or settings of at least one film extrusion machine, film parameters FP relating to the desired properties of the film, and raw material parameters RPn relating to the properties of the raw materials. The index n of the raw material parameters RP indicates that this is an entirety of raw materials from which one or more raw materials are selectable. The film production model is executed within the memory and computing unit, which detects the parameters mentioned above as entries and calculates from these which raw materials Rm are selected from the entirety of raw materials RPn. Alternatively or simultaneously, the required amount of the raw materials is also calculated. Here, the number of selected raw materials must be less than equal to the number the entirety of raw materials, i.e., m≤n.

FIG. 4 shows a changed process of the method according to the invention. It is comparable to the schematic illustration according to FIG. 3, however, the expected properties of the film FPv are also output.

### REFERENCE SIGN LIST

10 Film extrusion machine
20 Extruder
30 Die
40 Film web
50 Winding roll
60 Dosing device
100 Memory and computing device
R1, . . . Raw material
Rx, . . . Raw material
MP Machine parameter
FP Film parameter
RPn Raw material parameter for the total quantity of raw materials
Rm Selected raw materials
FPM Film production model

1. A method for producing a film from a total quantity of raw materials using an extrusion machine, comprising the following steps:
detecting machine parameters relating to properties and/or settings of at least one film extrusion machine,
detecting film parameters relating to desired properties of the film,
detecting raw material parameters relating to properties of the raw materials,
inputting the detected parameters in a film production model,
calculating a selection and/or an amount of raw materials from the total quantity on raw materials based on the detected parameters and the film production model,
outputting information relating to the selection and/or the amount of raw materials.

2. The method according to according to claim 1, additionally comprising the following step:
specifying a recommendation of a film extrusion machine on which the film is produced.

3. The method according to according to claim 1, additionally comprising the following step:
calculating the expected properties of the film based on the film production model.

4. The method according to claim 1, additionally comprising the following step:
considering previous orders when calculating the selection and/or amounts of raw materials.

5. The method according to claim 1, additionally comprising the following steps:
detecting batch-specific properties of at least a part of the raw materials,
considering said batch-specific properties,
calculating a selection and/or amount of raw materials.

6. The method according to claim 1, additionally comprising the following steps:
detecting at least one property of the film,
calculating the deviation of said property from the expected property of the film,
inferring at least one property of a raw material.

7. A computer program product comprising instructions which, when the program is executed on a computer, cause the computer to carry out the steps of a method comprising the features of claim 1.
